(19) United States
(12) Patent Application Publication
(10) Pub. No.: US 2026/0192204 A1
(43) Pub. Date: Jul. 9, 2026

(54) SYSTEM AND METHOD FOR MULTI-PLAYER IMMERSIVE BALL STRIKING GAME WITH POINT OF CONTACT AND PERSPECTIVE CORRECTION

(71) Applicant: Immersive Golf Holdco, LLC, Flower Mound, TX (US)

(72) Inventors: Thomas William Schier, JR., Flower Mound, TX (US); Jason Bernard Haddock, Sunninghill (GB); Tomas Lucas Cupido, Stellenbosch (ZA); Brendon John Smuts, Stellenbosch (ZA)

(21) Appl. No.: 19/568,478

(22) Filed: Mar. 16, 2026

Related U.S. Application Data
(63) Continuation-in-part of application No. 18/778,589, filed on Jul. 19, 2024, now abandoned.
(63) Continuation-in-part of application No. PCT/US2025/038317, filed on Jul. 18, 2025.

(51) Int. Cl. A63F 13/812; A63F 13/46

(52) U.S. Cl. CPC A63F 13/812; A63F 13/46

(57) ABSTRACT

A multi-player golf or other ball-striking game device enabling simultaneous or non-simultaneous play by multiple players at a time hitting balls onto the same screen and having a sensor and computer server configured to generate vector data regarding ball movement and point of impact with the screen, the server connected to the at least one screen, the server including: a projector or targeter element for projecting or conveying an image having a scorable area when impacted by a ball. The invention also provides a multi-player golf or other ball-striking game device that has point of contact correction and perspective correction.

### CROSS-REFERENCE TO RELATED APPLICATION

This non-provisional application is a continuation-in-part of and claims the benefit of, and priority to, U.S. non-provisional application Ser. No. 18/778,589, filed Jul. 19, 2024, entitled A SYSTEM AND METHOD FOR IMMERSIVE BALL STRIKING GAME, and which is incorporated by reference in its entirety for all purposes.

### FIELD OF THE INVENTION

The present invention is directed, in general, towards ball striking simulators and ball striking game entertainment, including but not limited to golfing entertainment, and, more specifically, to a multi-player, computer simulation ball striking target game, including those simulating baseball or tennis ball hitting, soccer, rugby, or football kicking, or golf ball hitting, which enables essentially simultaneous play among multiple players hitting or otherwise striking a ball onto the same common target screen.

### BACKGROUND

Ball striking games, including cricket, baseball, football, rugby soccer, tennis, and golf have a long history. For example, the modern game of golf originated in 15th century Scotland. Today, the game boasts millions, perhaps tens of millions, of adherents around the world. Golf has a traditional manner of game play, typically involving one player of a “foursome” at a time hitting a ball, which can land far away in a wide area, usually onto a “fairway.” After each player of the foursome takes his or her turn, each of the balls must then be found by the player that hit the ball, walking on foot or riding in a golf cart. Then the balls are each hit again, by each player in turn, gradually leading to the hole. All of this makes game play inherently slow and also limits the number of full-power tee shots (called “drives”) to, typically, about 18 per full game. Players of a foursome typically spend a large amount of time traveling over wide expanse of a golf course to find the resting place of their respective balls, which are usually separated by 10 yards or more, which reduces socialization opportunities. Traditionally, on the putting green, most players stay quiet while another player putts, which also reduces opportunities to socialize. Furthermore, players of a given foursome have little interaction with other foursomes during play, even when several foursomes are simultaneously playing on the course as part of a larger group (such as members of a company or social club), further reducing opportunities for socializing. As such, the manner of play of a traditional game of golf on a golf course can take many hours and have limited opportunities socialize, except for time spent in a golf cart or at the “19th hole,” after play is complete.

Conventional golf simulators, where a single player hits a golf ball toward a nearby small screen, generally up 100 square feet in area, and relatively close; less than twenty feet away from the player. The screen displays a projected image of a golf course, and a sensor or sensors track the path of the ball after is hit until it impacts the screen. Once the ball hits the screen, the computer simulates, based on physics-based computations, what the continued path of the ball would be if it was actually on the golf course that is simulated, based on the sensed trajectory and computed motion of the ball up to the point of impact with the screen, including the motion of the ball bouncing and rolling down the fairway. After multiple hits, the player moves the ball down the virtual fairway, onto the green and, ultimately into the hole. It is possible for multiple single-screen simulators to be employed. However, in this case, each group of players at each simulator and its screen still hit the ball onto the same small screen and must play in turn. Other groups of players would play on a separate tee-off area with its own separate screen spaced apart from the first group's tee and screen, possibly with an entirely different golf course being projected and simulated, though they can, in some cases, compete against people in other locations.

Conventional simulators improve some aspects of the traditional game of golf, including the speed of play, because it is not necessary for each player to physically walk down a long fairway to find his or her ball before being able to hit it again. However, otherwise, game play proceeds similarly to a traditional golf game played on a physical golf course. In conventional golf simulators, the speed of play is still limited by that fact that, after the ball impacts the screen, often less than a second after the ball is hit, the simulator projects the calculated path of the ball as it simulates it flying down the fairway, bouncing and then rolling and slowing until it reaches its simulated stopping place, which can take up to a minute. Once the ball stops, if there is a group of players playing together on the same simulated course and screen, as is typical, the next player would take his or her turn. Thus, other than players not having to physically walk down the fairway or ride in a golf cart, play proceeds much like traditional golf game, with most of the same limitations, including those relating to socialization opportunities.

Still further, the scoring and manner of play of traditional golf, which are usually only well-known to persons who play golf regularly, would still apply to golf played on a conventional golf simulator. As such, interest in playing on golf simulators is, in general, primarily only of interest to persons already well-versed in playing traditional golf. Another type of golf game apparatus, commonly called a golf entertainment venue, is exemplified by that provided by TopGolf International, Inc. Such a golf entertainment venue provides for hitting golf balls by individual plays of an inter-competing group from a tee-off area (one tee-off area per inter-competing group), one-player-at-a-time, into an open, outdoor, generally horizontally flat arena with real or artificial grass, much like a conventional driving range. A special micro-chipped ball is used for tracking ball trajectory. After the ball is hit toward the open outdoor arena, it will fly, bounce, roll and ultimately come to rest somewhere on the horizontal surface of the arena. After the ball is hit, its tracked trajectory flies, bounces, rolls and ultimately stops in the outdoor arena is determined by a computer, and displayed on a separate computer monitor viewable by the players of that inter-competing group. The computer monitor can display a number of backgrounds, including a simulated golf course, or fantasy themes and targets. The computer monitor is not an impact screen, however, and is not in a normally hittable location. There is no upright impact screen with displayed target images; rather, players hit into the open outdoor arena with its horizontal surface and come to rest on that horizontal surface (or a hole therein) only.

Players at other tee-off areas, which may be from different inter-competing grounds, although they could incidentally hit a ball at the same time as a player at tee-off area, are not necessarily presented with the same images on their respective monitors at the same time. That is, for each separate inter-competing group, all members of that group play must play from a single tee-off area for their group, one player at a time, hitting into the arena, with the ball trajectory tracked onto the game and background of only that inter-competing group's computer monitor being shown.

The foregoing simulator and golf entertainment games allow competition against others, usually with all players of a particular inter-competing group playing at the same tee-off area. For the players of any particular inter-competing group in one tee-off area, it is one player taking a turn at a time to hit, with one ball being tracked at a time for each such. Although it is possible to play competitions between tee-off areas (also called “bays”), all players at a single bay are not hitting to the same screen, or any screen, and are not playing cooperatively (but could play competitively). Within each bay, players are always playing one at a time vs simultaneously.

Although the use of a single perspective view in-game is good for a single, centrally located bay (e.g., a tee position in golf), for multi-player experiences, using conventional ball tracking systems, like InRange™, the shots of off-center players appear to bend away from the trajectory path as the player would view the ball travelling in real life. This can also makes it appear that, although the player may have hit a scorable area of an object at the physical point it is projected onto the surface of the screen, when scorable target is on an object that is shown as being down-range, and when the depth perception of the perspective view is taken into consideration, the game computer may not register a hit. The present applicant has determined that this is because, when the computed trajectory of the ball past the screen and on to the apparently down-range (as perspectively viewed) target is computed, the target would not have been hit. The applicant has determined that this undesirably breaks player's expectations, since a player that sees his/her ball hit a scoreable area where it is displayed on the surface of the impact screen, in general, expects to receive a score for doing so.

Another problem that exists in prior efforts to apply golf simulator technology adapted for single-player golf simulators to use with multiple players is that at least one, and sometime many, of the players in multi-player games hit from tees are not centrally located near the center of the screen. This results in a computed ball trajectory for their balls, as displayed on the screen, being warped for the players positioned at ball striking locations that are not centrally located in front of the impact screen. This also breaks with the player's expectations of how the simulated ball flight trajectory projected onto the screen should look, which undesirably may cause players to erroneously attempt to “correct” for their shots appearing to hook or slice, when their shots are, in fact, straight shots at the target displayed on the screen, with no hook or slice.

Accordingly, there is a need for an improved golf simulator that addresses and overcomes at least some of the drawbacks of the prior art, including those of both the traditional game or golf, conventional computerized golf simulators, and conventional golf entertainment venues, particularly though not exclusively as applied to multi-player games.

### OBJECTS OF THE INVENTION

It is an object of the present invention to provide a ball striking game, including but not limited to a golf-type game, where multiple players use golf clubs or other strikers, including feet, to hit balls toward the same common screen, hitting at will and, when desired, simultaneously, at one or several scorable computer-generated images of targets projected onto the common screen, which can be images of anything having a scorable area, such as bulls eyes, planets, space aliens, zombies space ships or any other desired image, stationary or moving, and where scoring is achieved essentially immediately, as soon as a sensor and computer system (referred to as a “monitor” system herein) determines the expected or actual initial impact position, whether it is in a scorable area, and the amount of the score.

It is a further object to increase the variety of games possible, speed of play and provide a more robust, interactive spectator experience over traditional golf, golf entertainment venues and conventional simulators, by providing for multiple players to play and hit at will, including simultaneously, on a common impact screen, up to as fast as each of the players can physically swing his or her club, bat, foot, etc., as the balls are repositioned for another strike at the ball.

It is a further object of the present invention to provide an improved golf simulator that addresses and overcomes at least some of the drawbacks of the prior art, particularly as applied to multi-player simulators where multiple players can hit at will against a common screen, including those of both the traditional game of golf, conventional computerized golf simulators, conventional golf entertainment venues, and other ball striking simulators.

### SUMMARY OF THE INVENTION

These and other objects are accomplished in accordance with the invention, which, in one aspect, provides a multi-player golf game device enabling play by multiple players hitting balls at will, including simultaneously, having at least three adjacent single-player tee-off areas for holding a golf ball, the center of each of said tee-off areas being spaced apart at least eight feet from the others and generally in a line facing the same target screen, the majority area of which is generally upright, the center of each tee-off area being disposed in a position for hitting a golf ball by a golf club swung by a player addressed at a ball on his or her tee-off area, and positioned so that, when the golf ball is hit in a normal manner toward the center of the screen, it is likely to impact the screen. This aspect of the invention further has one or more light projectors for projecting at least one computer-generated image onto the same target screen, which image includes at least one target image having a scorable area; the target screen being configured to receive light from the projector and to display at least one projected target image having a scorable area; further to receive the impact of a golf ball driven by a golf club swung by any of the players positioned at any of the tee-off areas, the screen having a generally upright area of at least 800 square feet and being disposed at least 30 feet away from the center of each of the tee-off areas; at least one sensor for determining the location a golf ball hit from each of the tees has or will impact onto the screen after being hit, and which player hit which golf ball, whether the golf balls hit by different players will impact the screen at the same time or different times; and a suitably programmed computer for comparing the location of impact of a golf ball onto the screen hit by any of the players and determining whether that location is within the scorable area of the at least one image and, if so, storing an achieved score for the player who hit the golf ball onto the scorable area.

The system preferably has a launch monitor including at least a sensor above each tee-off station to sense, at least, initial speed, direction and spin. Each launch monitor includes at least one sensor sensing the ball motion from the time it is hit. The launch monitor is connected to a suitably programmed microprocessor to digitize the signals, the signals for each monitor then being sent to a server system. Once the initial speed, direction and spin signals from the sensor or sensors are digitized, the digitized data is then input into a microprocessor, either included as part of the launch monitor at each station, or in the server, which will then calculate the trajectory of the ball from the instant it is hit from that respective station to where it would hit on the target screen. In this way, the technology tracks each ball from the multiple stations and knows where exactly each will hit on the screen and by which station it was hit, even if all the balls are hit simultaneously. That data is incorporated into the game to determine if a target/object has been or will be hit, and what the achieved score is for that hit. The game is designed with the scoring point values per target or object and scores the game by person to allow competitive or cooperative games by all players hitting at will, including simultaneously, onto a common screen that has a generally upright area of at least 800 square feet.

The games use projection mapping technology to project the images onto the screen on the main wall but also can use multiple projectors to show images on ceiling and side walls to allow an immersive experience.

In a variation of this aspect of the invention, the computer has an arithmetic unit for calculating each player's running total score.

In a variation of this aspect of the invention, the computer has an output to the light projector for projecting the score onto the screen.

In a variation of this aspect of the invention, the computer has an output to the light projector for projecting each player's running total score onto the target screen.

In a variation of this aspect of the invention, the target screen has a side edge and a side wall target screen disposed at an angle with respect to the side edge, the second screen being configured to receive light from at least one projector to display at least one projected target image having a scorable area and to receive the impact of a golf ball driven by a golf club swung by at least one of the players from any of the tee-off areas.

In a variation of this aspect of the invention, the target screen has a generally upright main portion having at least 800 square feet, a top edge and a ceiling portion disposed at an angle with respect to the top edge, the ceiling screen being configured to receive light from at least one of the projectors to display at least one projected target image having a scorable area; and further to receive the impact of a golf ball driven by a golf club swung by at least one of the players at any of the tee-off areas.

In a variation of this aspect of the invention, the sensor senses multiple parameters correlated to golf ball movement, the parameters comprising a vector.

In a variation of this aspect of the invention, the vector includes the parameters of at least speed and direction.

In a variation of this aspect of the invention, the vector further includes the parameter of golf ball spin speed and axis of spin.

In a variation of this aspect of the invention, the sensor comprises a camera pointed at the screen to sense location of a golf ball at the time of impact with the screen.

In a variation of this aspect of the invention, the multi parameters are sufficient to determine at least speed of the golf ball at the time of impact with the screen.

In a variation of this aspect of the invention, the multiple parameters are sufficient to determine at least direction of the golf ball at the time of impact with the screen.

In a variation of this aspect of the invention, wherein the score is different for different locations of impact within the scorable area.

In a variation of this aspect of the invention, the score is different for different speeds of impact within the scorable area.

In a variation of this aspect of the invention, the score is different for different directions of impact within the scorable area.

In another aspect of the invention, a multi-area golf play device having a set of multiple, multi-player golf game devices, each of which is segregated into a separate physical area and enables play by multiple players hitting balls at will, including simultaneously, and wherein each of the multiple, multi-player golf game devices comprises a multi-player golf game device enabling play by multiple players hitting balls at will, including simultaneously, having at least three adjacent single-player tee-off areas for holding a golf ball, the center of each of said tee-off areas being spaced apart at least eight feet from the others and generally in a line facing the same target screen, the center of each tee-off area being disposed in a position for hitting a golf ball by a golf club swung by a player addressed at ball on his or her tee-off area, and positioned so that, when the golf ball is hit in a normal manner toward the center of the screen, it is likely to impact the screen. This aspect of the invention further has one or more light projectors for projecting at least one computer-generated image onto the same target screen, which image includes at least one target image having a scorable area; the target screen being configured to receive light from the projector and to display at least one projected target image having a scorable area; further to receive the impact of a golf ball driven by a golf club swung by any of the players at any of the tees, the screen having an area of at least 800 square feet and being disposed at least 30 feet away from the center of each of the tee-off areas; at least one sensor for determining the location a golf ball hit from each of the tees has or will impact onto the screen after being hit, and which player hit which golf ball, whether the golf balls hit by different players will impact the screen at the same time or different times; and a suitably programmed computer for comparing the location of impact of a golf ball onto the screen hit by any of the players and determining whether that location is within the scorable area of the at least one image and, if so, storing an achieved score for the player who hit the golf ball onto the scorable area.

In a variation of the foregoing aspect of the invention, the multi-area golf game device further comprises a competitive socializer element that allows for a competition between separate groups of players, each of which is playing on a screen in one of the multi-player golf game devices segregated into its own separate physical area.

In another variation of the foregoing aspect of the invention, the multi-area golf game device further comprising a competitive socializing element.

### Point of Contact and Perspective Correction

In another aspect, the present provides a multi-player ball striking game device enabling play by multiple players striking balls at will in the direction of a target screen having a front surface configured as an exposed impact surface to receive impact from the balls, including from players striking balls simultaneously having at least two adjacent single-player ball striking-off areas for holding each ball, the center of at least one of said striking-off areas being spaced apart substantially equally at least eight feet from the others and generally in a line facing the target screen, the target screen being the same target screen for all players and being positioned so as to be exposed on its entire front surface to direct impact by a ball struck by any player, the center of each striking-off area being disposed in a position for hitting each ball by a strike delivered by a player addressed at the ball on his or her striking-off area, and positioned so that, when the ball is struck in a normal manner toward the impact screen, it is likely to impact the target screen, and wherein at least one of which striking off areas is an oblique striking off area disposed off-center from a centrally-located vertical plane through the target screen. This aspect of the invention further has one or more light projectors for projecting at least one computer-generated image onto the target screen, which image includes at least one target image having a scorable area; the target screen being configured to receive light from the one or more projectors and to display the at least one projected target image having the scorable area; and further to receive the impact of each ball driven by each strike delivered by any of the players from any of the striking-off areas toward the impact screen, the screen having a generally upright area and being disposed away from the center of each of the striking-off areas This aspect of the invention further includes at least one computer-controlled launch monitor device for determining the location a ball struck from each of the striking-off areas has or will impact onto the from impact surface of the impact screen after being struck, and which player struck which ball, whether that ball and/or other balls struck by different players will impact the impact surface of the target screen at the same time or different times; the computer-controlled launch monitor device being further configured to compare the location of impact of a ball onto the impact surface struck by any of the players and to determine whether that location is within the scorable area of the at least one target image and, if so, to apply and store an achieved score for the player who struck the ball onto the scorable area; the score is being achieved substantially immediately upon it being determined that the ball has or will impact the front surface of the target screen at the location that the scorable area is displayed onto the front surface.

In a variation of this aspect of the multi-player ball striking game device, the computer generated image is a perspective image having an apparent depth resulting in the scorable area of the image having an apparent position past the front surface of the target screen that represents a substantia portion of that apparent depth, and provides that the score is achieved immediately even where the apparent position of the scorable area of the image appears to be substantial distance past the front surface of the target screen as a result of the apparent depth of the perspective image.

In another variation of this aspect of the multi-player ball striking game device, the at least two adjacent single-player ball striking-off areas include at least one oblique striking off area located obliquely to a centrally located vertical plane through the impact screen, and wherein the computer-generated image includes an image showing a trajectory of the ball hit from the oblique striking off area towards the impact screen that generally represents the trajectory that would be observed by a person striking the ball from that oblique striking off area toward the impact screen.

In another variation of this aspect of the multi-player ball striking game device, the image of the trajectory forms part of the computer-generated image.

In another variation of this aspect of the multi-player ball striking game device, the trajectory image of a ball struck from the oblique striking off area is first computed in a first step by a computerized trajectory calculation system to determine an initial trajectory of the ball as it would be observed a centrally-located striking off area, and computationally modified in a second step by trilateral computations to compute a final trajectory that generally represents the trajectory that would be observed by a person striking the ball from that oblique striking off area toward the impact screen, and wherein both the first step and the second step are accomplished substantially in real-time.

In another variation of this aspect of the multi-player ball striking game device, the computer has an arithmetic unit for calculating each player's running total score.

In another variation of this aspect of the multi-player ball striking game device, the computer has an output to the light projector for projecting the score onto the screen.

In another variation of this aspect of the multi-player ball striking game device, the computer has an output to the light projector for projecting each player's running total score onto the target screen.

In another variation of this aspect of the multi-player ball striking game device, the target screen has a front and side edge connecting contiguously to a side wall portion disposed at an angle with respect to the front of the target screen and extending from it, the side wall portion also being configured to receive light from at least one projector to display at least one projected target image having a scorable area and to receive the impact of a ball driven by a strike delivered by at least one of the players from any of the striking-off areas.

In another variation of this aspect of the multi-player ball striking game device, the target screen has a front and a top edge connecting contiguously to a ceiling portion disposed at an angle with respect to the top edge and extending from it, the ceiling portion also being configured to receive light from the at least one projector to display the at least one projected target image having the scorable area and being exposed on its entire surface to direct impact by a ball struck by any player to receive the impact of each ball driven by a striker each strike delivered by at least one of the players.

In another variation of this aspect of the multi-player ball striking game device, a sensor senses multiple parameters correlated to ball movement, the parameters comprising a vector.

In another variation of this aspect of the multi-player ball striking game device, the vector includes the parameters of at least speed and direction.

In another variation of this aspect of the multi-player ball striking game device, the vector further includes the parameters of ball spin speed and axis of spin.

In another variation of this aspect of the multi-player ball striking game device, a sensor is provided that comprises a camera pointed at the screen to sense location of a ball at the time of impact with the screen.

In another variation of this aspect of the multi-player ball striking game device, the multi multiple parameters are sufficient to determine at least speed of the ball at the time of impact with the screen.

In another variation of this aspect of the multi-player ball striking game device, the multiple parameters are sufficient to determine at least direction of the ball at the time of impact with the screen.

In another variation of this aspect of the multi-player ball striking game device, the score is different for different locations of impact within the scorable area.

In another variation of this aspect of the multi-player ball striking game device, the score is different for different speeds of impact within the scorable area.

In another variation of this aspect of the multi-player ball striking game device, the score is different for different directions of impact within the scorable area.

In another variation of this aspect of the multi-player ball striking game device, the device further comprises a competitive socializer element.

### BRIEF DESCRIPTION OF THE DRAWINGS

FIG. 1 illustrates an exemplary environment as described herein, wherein a golf-type game is both a golf ball hitting game and an immersive experience, including elements of competitive socializing.

FIG. 2 illustrates an exemplary plurality of multi-player immersive multi-player golfing environments.

FIG. 3A illustrates a prior-art movie theatre architecture.

FIG. 3B is a diagram of FIG. 3A updated with spectator seating, queuing lines, and event/meeting space for an immersive multi-player golfing and competitive socializing experience

FIG. 4 illustrates exemplary forms of immersive multi-player golf to be used in the environment of FIG. 1.

FIG. 5 illustrates an example of immersive multi-player immersive golf during peak play time.

FIG. 6 illustrates an example of immersive multi-player golf during non-peak play time.

FIG. 7A illustrates an exemplary computer system for employment of an immersive multi-player golfing and competitive socializing experience, such as FIG. 1.

FIG. 7B illustrates the first screen having a side edge and a side wall target screen disposed at an angle with respect to the side edge and extending from it.

FIG. 7C illustrates the first screen having a top edge and a ceiling target screen disposed at an angle with respect to the top edge and extending from it.

FIG. 8 illustrates an exemplary method for employing the immersive multi-player golfing and competitive socializing experience, such as the environment of FIG. 1.

FIG. 9 depicts a configuration page having an inner rectangle generated by the computerized projection computer program, used for configuring the projection program during set-up to properly display the game image on the impact screen.

FIG. 10 depicts another view of the configuration display generated by the computerized projection computer program showing the proportions of the inner and outer rectangles as displayed on the impact screen.

FIG. 11 depicts another configuration page generated by the computerized projection computer program showing the proportions of a configuration inner triangle disposed within the inner rectangle depicted in FIG. 9 with its apices touching the bottom corners and midpoint of the top side of the inner rectangle, as displayed on the impact screen.

FIG. 12 depicts a simplified perspective view from the left and above of a horizontal set of three adjacent tee point striking positions, the set being arranged with respect to a generally vertical impact screen upon which the configuration inner triangle of FIG. 11, with dotted lines indicating three distance measurements to be made between the apices of inner triangle to the left-most tee during configuration.

FIG. 13 depicts a simplified schematic view of how the inner and outer rectangles of the configuration display page of FIG. 9 would appear as projected onto the impact screen as installed.

FIG. 14 depicts schematically the configuration inner triangle disposed within the rectangle depicted in FIG. 9 with both superimposed onto the inner rectangle, as depicted in FIG. 9 and separately.

FIG. 15 depicts a simplified orthogonal view of one set of dotted lines indicating three distance measurements to be made during configuration between the apices of the inner triangle to one of the tees where a ball is to be struck.

FIG. 16A depicts a simplified perspective view from the left and above of a real-world arrangement of a tee arranged with respect to a vertical impact screen as installed showing an example ball flight path as detected by an overhead launch monitor device.

FIG. 16B depicts a simplified perspective view of the virtual environment showing a simulated flight path representing the actual ball flight path as detected by the overhead launch monitor device of FIG. 16A.

FIG. 17 depicts a simplified side view from the right of the virtual environment showing the simulated flight path represented by a set of calculated points in space of the simulated ball flight path depicted in FIG. 16B.

FIG. 18 depicts a simulation of a bird's eye view of four adjacent ball flight paths for four balls hit from, respectively, four horizontally spaced apart tee points straight ahead toward a generally vertical impact screen.

FIG. 19 depicts a simulation of the four adjacent simulated ball flight paths for four balls hit from, respectively, four horizontally spaced apart tee points straight ahead toward the generally vertical impact screen of FIG. 18, as they would appear to a centrally located observer viewing the front surface of the impact screen, prior to application of the perspective correction of an embodiment of the present invention.

FIG. 20 depicts a simulation of a bird's eye view of four adjacent simulated ball flight paths for four balls hit from, respectively, four horizontally spaced apart tees straight ahead toward a vertical impact screen, as they would appear to a centrally-located observer viewing the front surface of the impact screen, viewed from above, after application of the perspective correction of the present invention.

FIG. 21 depicts a simulation of the four adjacent simulated ball flight paths for four balls hit from, respectively, four horizontally spaced apart tees straight ahead toward a vertical impact screen of FIG. 18, as they would appear to an observer viewing the front surface of the impact screen, after application of the perspective correction of the present inventio.;

FIG. 22 depicts a schematic representation 2200 of a virtual bay from above, indicating a forward ball strike with a solid arrow normal to the impact screen, and a dotted line indicating a hit direction at a bay angle away from the normal line.

FIG. 23 depicts a schematic representation 2300 of a virtual tee from above, showing a hit from the left tee to the right, and a hit from the right tee to the left.

### DETAILED DESCRIPTION

Conventional prior art golfing simulators generally extrapolate a ball flight to hit a virtual target where the ball would land, including bouncing and rolling.

However, players within the immersive multi-player golfing simulation of the present application instead hit virtual targets having scorable areas projected onto the impact screen, and feedback and a score is given immediately or essentially immediately upon the ball hitting the screen in a scorable area thus, desirably, providing an “instant gratification” to the player. This is unlike prior art golfing simulators, which extrapolate the path of the ball out to where a golf ball would continue virtually through the screen and onto a golf course fairway, as if the screen was not physically there, and the only scoring occurs when the ball ultimately reaches the virtual hole.

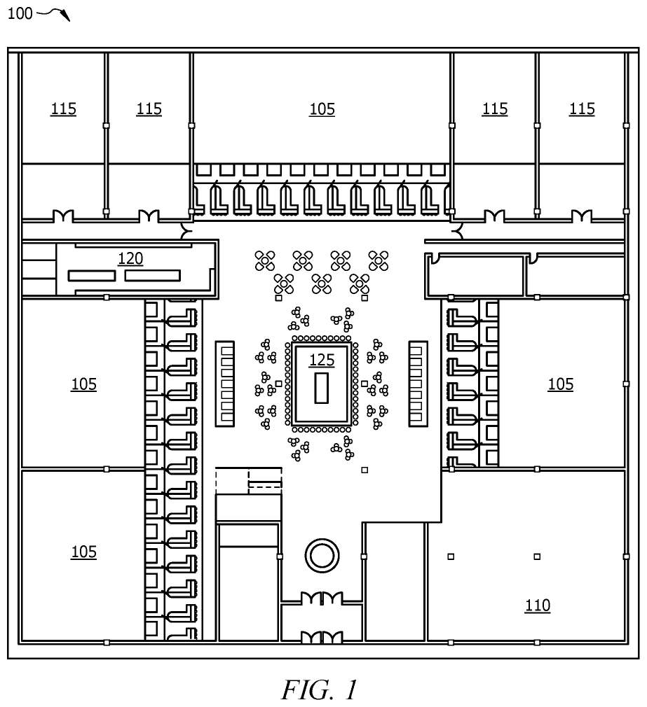

FIG. 1 illustrates an overall immersive golfing environment (“environment”) 100 in an entertainment venue, such as a seating area for persons when not playing, including a restaurant, which can further include enhancements for competitive socializing in this game and other social interactions.

In the illustrated environment, there are a plurality of immersive multi-player golf theatres 105 wherein each theater can have a different game and customers would move from theatre to theatre to play different games. Each theatre and game have the same or different projected images having scorable areas (also referred to herein as devices for “conveying targeting,” that is, projecting or otherwise delivering an image having a scorable area to the screen), enhancements for competitive socializing and overall immersion, which can include an immersive eighteen-hole putting course 110, a plurality of private theatres 115 (for exclusive group rentals), a kitchen 120, and a bar 125 with seating. Each one of these items combines synergistically to create a social environment which can be a competitive social environment for the immersive environment, which can include social competitiveness.

In the immersive multi-player golf theatres 105 and 115, play can allow a number of fun interactions that would typically not be available in prior art golfing simulators, such as teeing off multiple golf shots in a row within a single game without having to wait for a final position of where the golf ball would travel on a simulated fairway, as with conventional golf simulators and golf entertainment venues. It can also provide amusing moving or stationary images with scorable areas as “targets” for the player to attempt to hit with a struck golf ball, and with consequences from success or failure in doing so (e.g., trying to hit a golf ball to hit a ‘spaceship’ that is ‘attacking’, or amusing or entertaining ‘cowboy’ or ‘third-party shooter’ images, such as zombies, space aliens or clowns) that, when hit successfully, provide the golfer with a particular score, immediately or essentially immediately when the ball impacts the screen. This can increase the interest factor by the players, which can also lead to a revenue increase per game. Moreover, incorporating ‘pop culture’ elements into the targeting aspect of the environment 100 as discussed above can lead to a broadened appeal of golfing to a larger than the traditional audience for traditional golf on an actual course, golf entertainment venue or conventional golf simulators.

In a further embodiment, the immersive golf theatres 105 and 115, including multi-player ball tracking that occurs within the same game. Unlike the prior art, wherein the golf simulators, golf entertainment venues and outdoor places track one ball per game/bay, according to the principles of the present application, multiple players at all bays facing the common impact screen in a theater are hitting balls at will, including potentially simultaneously, and the environment 100 is tracking all in the same game within a theatre. This can also aid in a further goal of competitive socializing as different games will be in each theatre.

In a yet further embodiment of the immersive golf theatres 105 and 115, projections are mapped onto side walls and ceilings and bring those elements into useful interactions for a player within the environment 100. Wherein typically in the prior art, the prior art conventional golf simulators are focused on tracking the simulated ball flight to a simulated virtual point past the screen, the present application allows for a much faster play by assigning an achieved score for a hit at soon as the golf ball impacts a scorable area of an image conveyed to the screen.

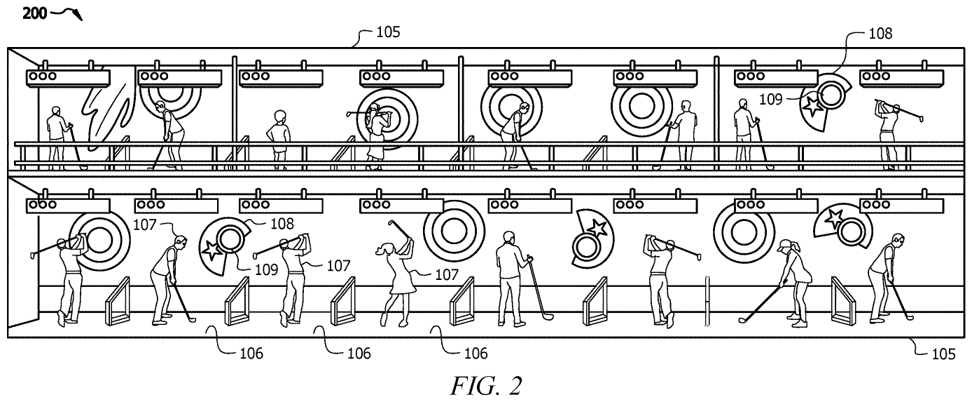

FIG. 2 illustrates an exemplary plurality of individual immersive multi-player, common screen, golfing theatres 105 in an immersion group 200, which can have one, two or more stories, each of which have at least three striking or, for golf, tee-off areas 106, including tees or other tee-off areas (such as carpets or artificial grass) for at least three players 107, though fewer than three players may actually play at any given time. There also can be a plurality of individuals 107 playing simultaneously in each immersive golfing theatre 105 and 115, up to the number of tee-off areas. Moreover, in further embodiments, the different immersive golfing theatres 105 and 115 can have different games in each theater or be simultaneously competing or cooperating with each other, wherein an image 108 having a scorable area (i.e. a target) 109 may be simultaneously projected onto the screen in in multiple ones of the theaters (each having a common screen for all players), allowing simultaneous play on a duplicated set of images 108 having scorable areas 109 in each theatre, by multiple separate groups (e.g. one group in each theater, with each theatre having the same set of images at the other theatres).

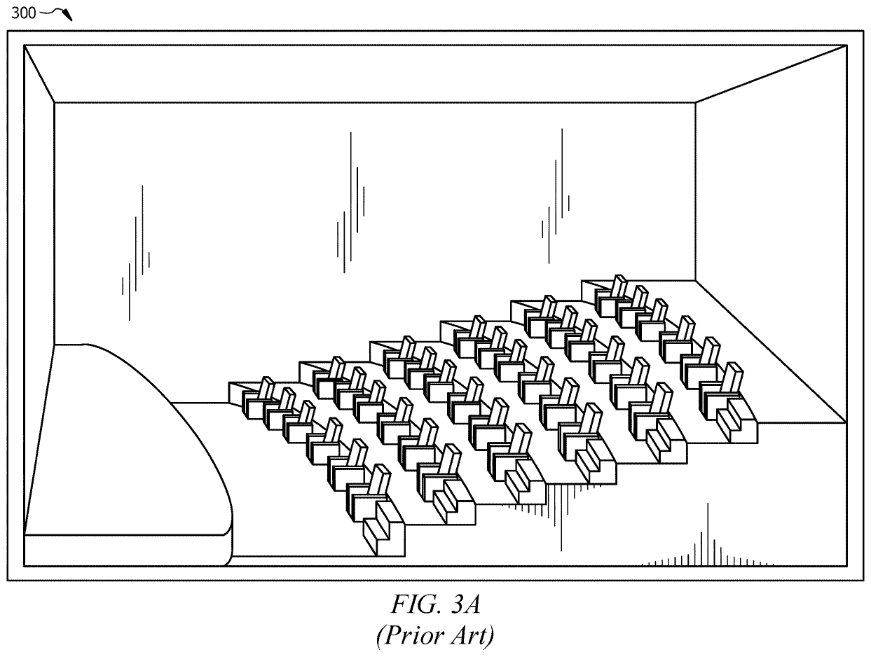

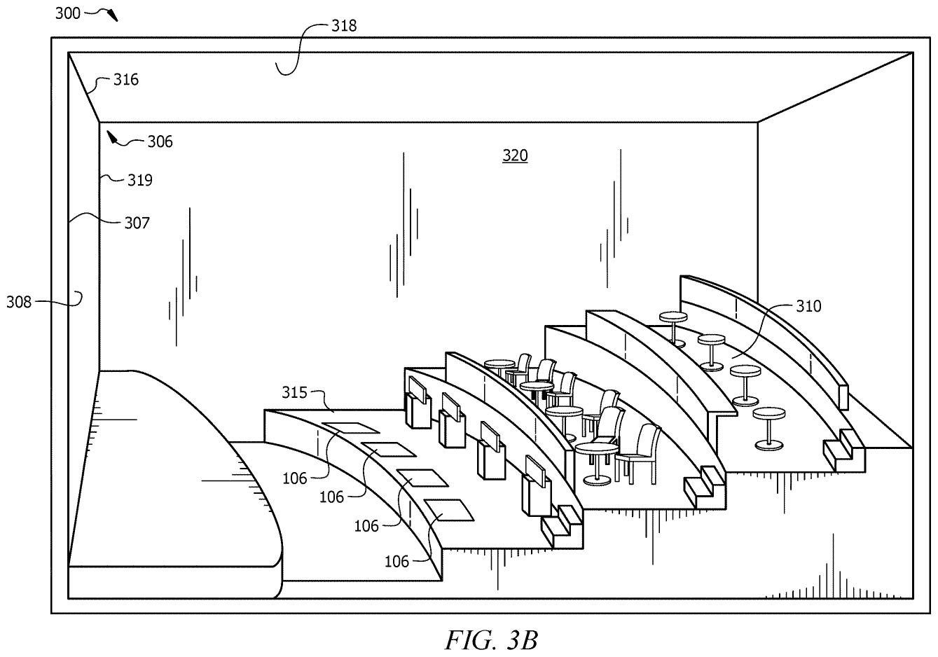

FIG. 3A illustrates a prior-art movie theatre seating.

FIG. 3B illustrates a diagram of the movie theatre seating of FIG. 3A, after it has been updated and refitted to an immersive multi-player golfing environment 300 with spectator seating 305, queuing lines, an event/meeting space 310, and multiple hitting areas 106 for an immersive multi-player golfing experience 315 constructed according to the principles of the present application. In a further embodiment, the environment 300 is also employed for competitive socializing. The hitting area 315 in a theatre 105 has a large common screen 307 for all players, and has at least a front, generally upright central face 308 having an area of at least 800 square feet and is facing the line or tee-off areas 106 for the players 107, and which receives images having scorable areas (not shown in FIG. 3B). In some embodiments, the front, central face 308 of the common screen 307 can have a top edge 316 adjoining, at an angle, a ceiling 318, which can also receive projected images, and side edges 319 adjoining side walls 320, which can also receive projected images. The projected images projected onto the ceiling and side wall or walls may, or may not, also include images having scorable areas

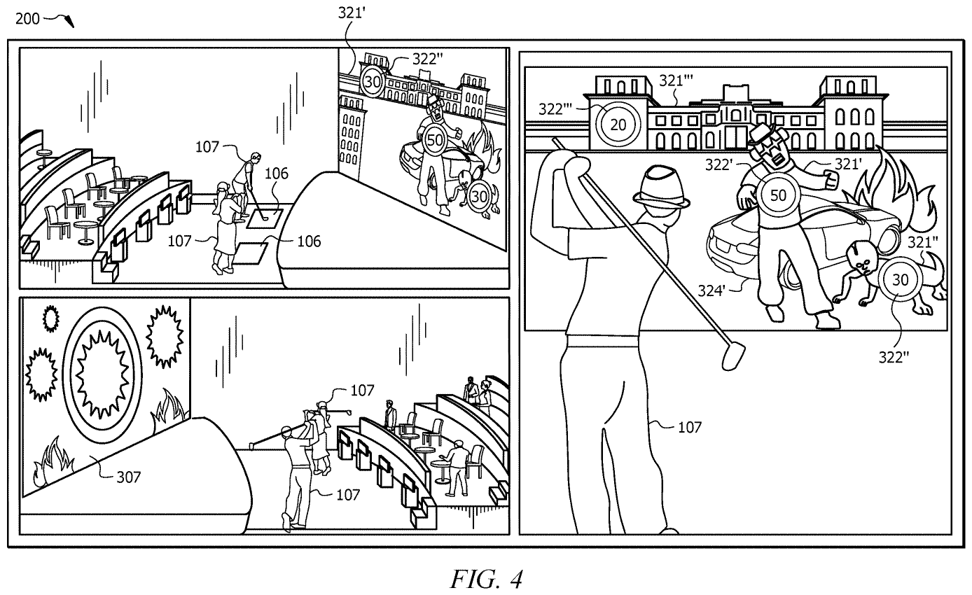

FIG. 4 illustrates exemplary forms of immersive golf to be used in the environment of FIG. 1 according to the principles of the present application. As discussed above, various golfers 107 are simultaneously attempting to hit targets 321 on the screen. In a first scenario 401, a golfer 107 is trying to strike images of various images 321, including, for example, comical FIGS. 321′, 321″ and 321″, and the scenario proceeds accordingly. In a second scenario 403, multiple golfers 107 are simultaneously having a social competition among each other within a golfing game to score the most points. In a third scenario 405, multiple golfers 107 are cooperating to hit certain scorable targets 322′, 322″ and/or 322″ to aggregate a score.

FIG. 5 illustrates immersive targeting golf games played by golfers 107 in various scenarios. In one embodiment, in ‘peak ‘immersive golf (i.e., golf played during the most popular playing times), the golf games are 3-6 minutes a piece, and can be multi player. In one embodiment, there can be multiple theatres for immersive golf per venue, so there can be many game options. The guests can move through the venue for golfing, from one theatre 105 to another. In a further embodiment, a group of players 107 plays the game, then a next group plays (which is more like a ‘tee time’ approach vs. pay by the hour approach), or alternatively can indeed pay by the hour.

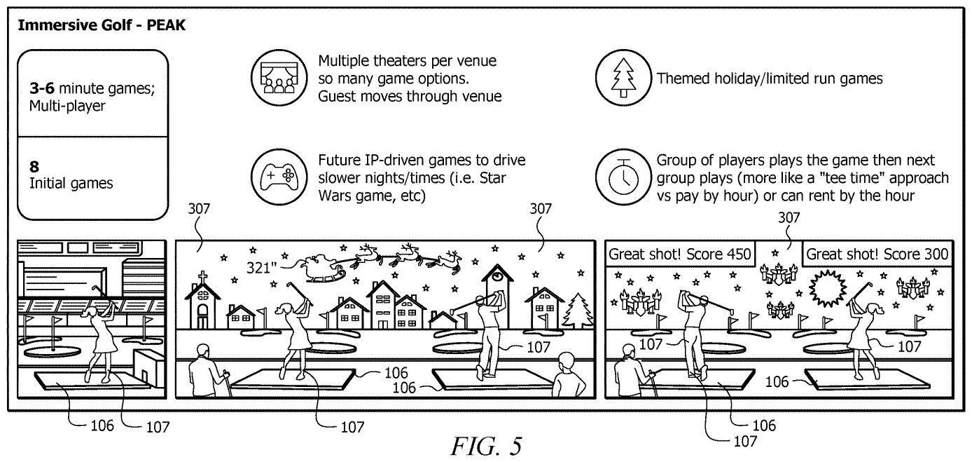

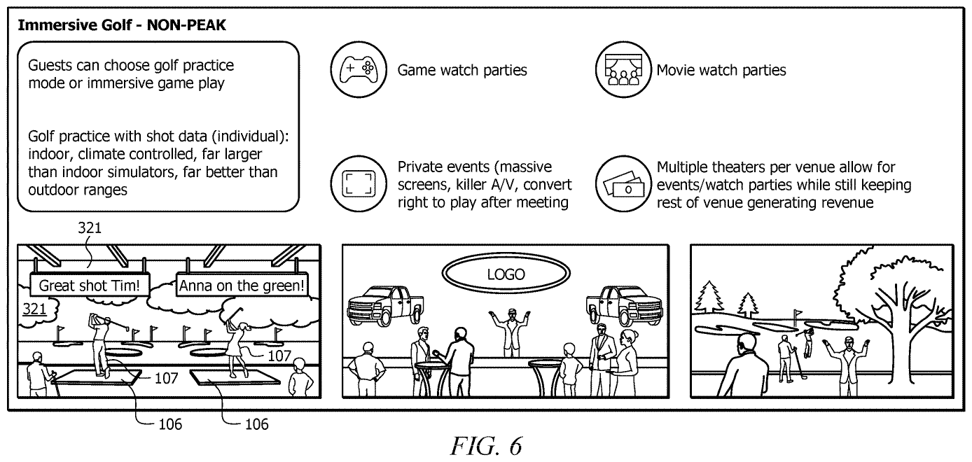

FIG. 6 illustrates a non-peak immersive golf game played by golfers in various scenarios. In one embodiment, in non-peak times, a guest can also choose golf practice mode or immersive. This non-peak time can include individualized shot data. In a further embodiment, the large screens can include game watch parties, private events, audio visual spectacles, and moreover, guests can start to play right after meeting one another. Movie-watch parties are also possible. In a yet further embodiment, multiple theatres per venue allow for events/watch parties, whilst still keeping the rest of venue generating revenue.

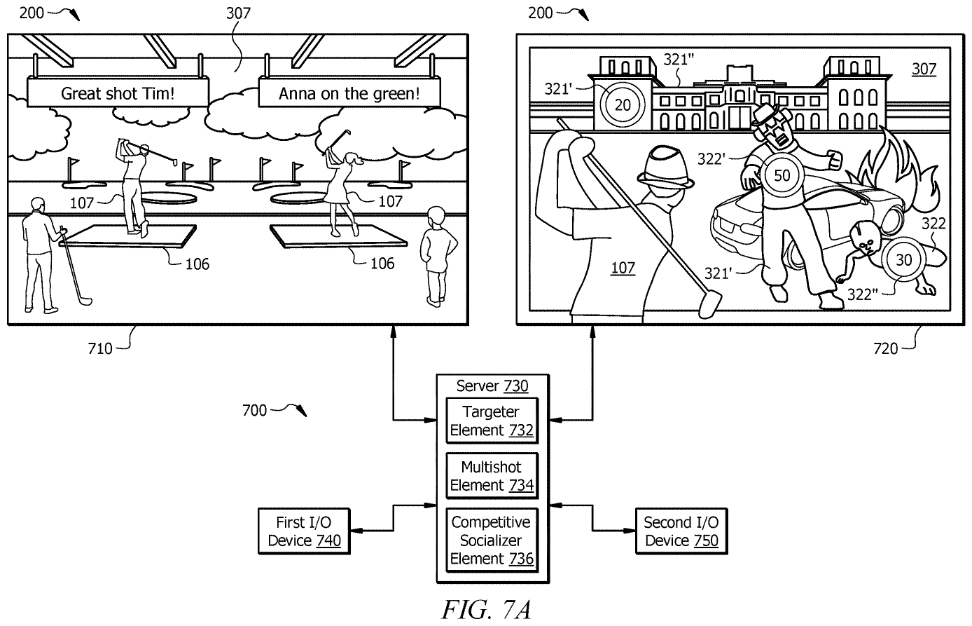

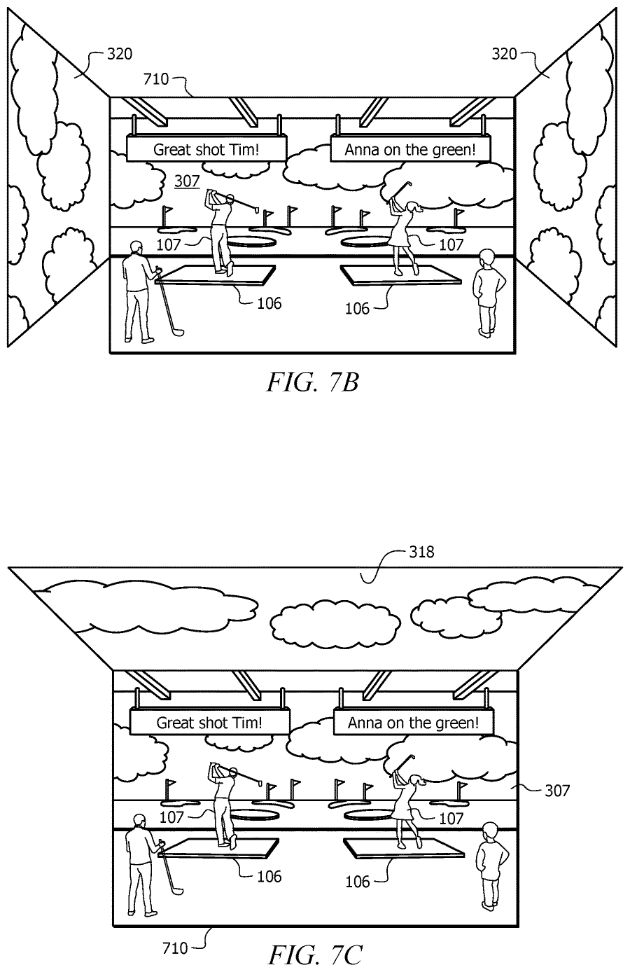

Turning now to FIG. 7A, illustrated is a device and system 700 constructed according to the principles of the present invention. In the system 700, a first screen 710 and a second screen 720 are connected to a server 730, each of which is in a separate theatre 105. Golf ball launch sensors (also called “monitors”), which may include a suitably programmed microprocessor for pre-processing and digitizing raw signals from the sensors, are placed above each station in screen 710 to sense multiple parameters correlated to golf ball movement, also referred to as “vector” information herein, and then convey this data (which can be in either analog or in digitized form) to the server 730 for processing for the virtual environment and determining which, if any target or object is hit on screen 720 (based on the computed trajectory) and awards the point values for that target or object.

In a further embodiment in a FIG. 7B, the first screen 710 has a side edge and a side wall target screen 320 disposed at an angle with respect to the side edge and extending from it. In another embodiment, depicted in FIG. 7C, the first screen 710 has a top edge and a top “ceiling” target screen 318 disposed at an angle with respect to the top edge and contiguously extending from it. In either case, the second screen is configured to receive light from at least one projector to display at least one projected target image having a scorable area and to receive the impact of a golf ball driven by a golf club swung by at least one of the players 107 from any of the tees 700 in any of the hitting areas 106, with the associated scoring conducted in the same manner as in the previous embodiments.

The server 730 includes a targeter element 732 and a multi-player, multi-shot element 734 which enables play by multiple players, individually and/or as a member of any inter-competing group or inter-cooperating group, from any or all tee-off areas, hitting balls at will, including simultaneously. The embodiment also includes a competitive socializer element 736, all of which can comprise processes, chips, or functions, etc.

The targeter element 732 allows for conveying or projecting targeting images having scorable areas onto a screen and the subsequent interaction with a golfer, and scoring, according to the principles of the present application. The multi-shot element 734 allows for multiple golf balls to be hit at will by multiple players, each to potentially strike the scorable areas of one or more images or targets in a single instance of a game, including when the balls hit by multiple players impact the screen simultaneously. The competitive socializer element 736 allows for the various competitive socialization functions of the game players, when not playing the multi-player golf game device.

The server 730 is connected to a first I/O device 740 to be used in conjunction with the first screen 710 for presentation and selection of options to a first group of users. The server 730 is also connected to a second I/O device 750 to be used in conjunction with the second screen 720 for presentations and selection of options to a second group of users.

Generally, the server 730 can be employed to generate a golfing simulation of the environment 100 to hit virtual targets right on the screen at the time and place of impact with the screen, rather than extrapolating out to where the golf ball would travel on a simulated fairway, if the screen was not present to stop the ball.

With employment of the server 730, this ‘targeting’ can allow a number of fun interactions, such as teeing off multiple golf shots in a row. Moreover, amusing ‘targets’ can be hit and consequences dealt with (e.g., trying to hit a golf ball to hit a spaceship that is ‘attacking’). Because any golfer can hit a ball immediately when ready, this translates to faster play than for conventional simulators, which can also lead to a revenue increase per game. Moreover, incorporating ‘pop culture’ elements into the targeting aspect can lead to a broader appeal of golfing to a larger audience than a traditional golfer audience.

In a further embodiment, with employment of the server 730, multi-player ball tracking occurs within the same game. Unlike the prior art, wherein the golf simulators and outdoor places track one ball at a time per game/bay, according to the principles of the present application, multiple players at all the bays in a theatre 105 can all be simultaneously hitting balls at the same common screen, and the server 730 is tracking all in the same game displayed on the same common screen. This can aid in the further goal of competitive socializing.

In a yet further embodiment, with employment of the server 730, projections can also be mapped onto side walls and ceilings and bring those elements into useful interactions for a player who interacts with the server 730. As such, the present application allows for a much broader range of hits and tracking of the golf balls hit by multiple players, all hitting at will, including simultaneously, at the same or different conveyed or projected targets.

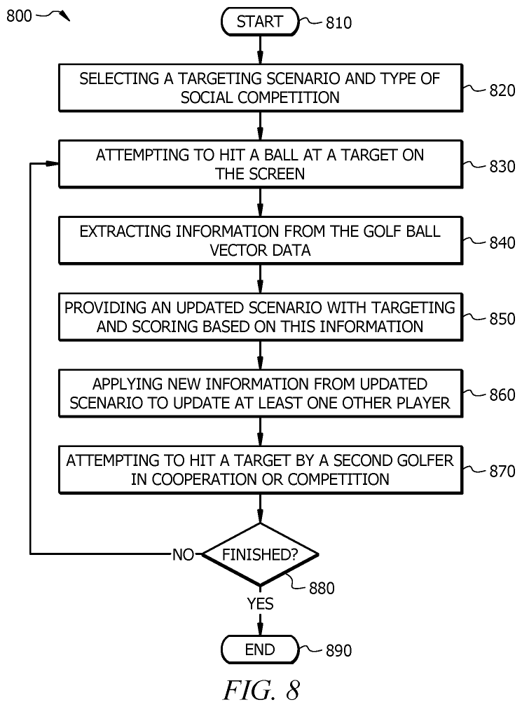

Turning now to FIG. 8, illustrated is a method 800. After a start step 810, in a select a scenario step 820, a golfer selects what type of immersive targeting experience he or she desires, as well as any social competition. In a step 830, a golfer attempts to hit a golf ball at a target on the screen. In a step 840, the server 730 employs extracted information from the golf ball vector information. In a step 850, the server 730 provides an updated scenario with targeting and scoring based on the golf ball vector information. In a step 860, new information is applied from the updated scenario to update another player or players, hitting from the same or different bays, that might be either cooperating or competing with the first golfer. In a step 870, the second golfer in competition (or with cooperation, which can be defined as a type of competition within the present environment for some embodiments), where the second golfer also golfs and tries to hit his or her own target, or a common target, but on the same common screen. That is, although the background on the screen is the same for all players, it is possible for players to score differently from other players if they hit a particular target, such as a blue target for one player and a red target for another player. It is also possible to have “mixing and matching” for players to compete or cooperate, individually, or in any or all inter-competing or inter-cooperating groups or combination thereof, simultaneously or not. In a step 880, it is determined whether the first golfer is finished with this game, or wishes to hit another golf ball. If so, the method loops back to step 830. If the first golfer wishes to no longer golf, the method stops in a step 890.

The following discussion describes the device, system and process by which a Point-of-Contact solution embodiment and a Perspective Correction embodiment of the present invention are constructed and used.

### Point of Contact Solution

The Point-of-Contact solution is a technique which enables capture of expected and/or actual ball-to-screen contact using club-ball impact ball tracking trajectory technology.

In order to achieve the Point-of-Contact solution referred to above, the steps of “configuration”, “point of contact translation”, and “point of contact perspective correction are described below.

### Configuration

The first step in both the Point of Contact solution and the Perspective Correction solution is configuration. This step is essential for constructing a virtual copy (that is, computer simulation) of the particular physical installation which enables constructing the simulation necessary for calculating a point of contact. This configuration includes the following steps:
1. Sets up the screen size,
2. Configures the bay positions relative to the screen; and
3. Screen Measurement.

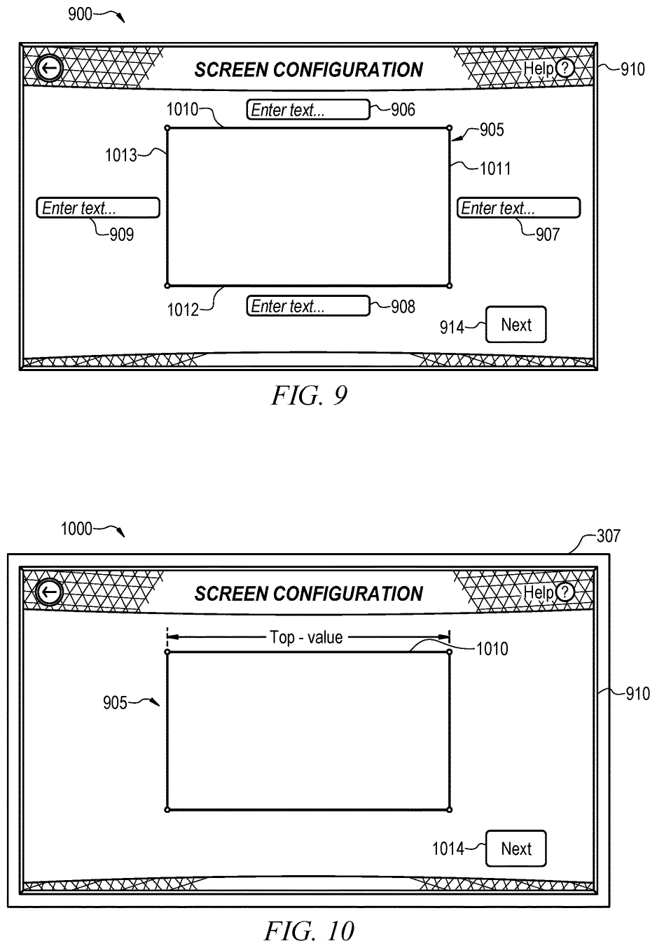

As shown in FIGS. 9 through 15, the screen measurement step at initial setup requires physical measurements of a projected UI (user interface) element on the physical impact screen during configuration of setup of the projector that will display images of target areas, background images, ball flight path (also referred to herein as trajectory) onto the impact screen during the game. This screen measurement image 900 is projected onto physical impact screen, such as screen 307 in FIG. 3B, to be used under the control of a set-up computer (not shown). For convenience, for set-up, a laptop computer or other PC (not shown) can be used for inputting the required values.

In order to make the required measurements, the following are required for the person making the measurements:
1. A computerized projector setup with a computerized ball striking game as previously described herein running, initially in set up mode.
2. The game must be running in fullscreen and the projector settings must be configured to ensure suitable screen coverage (i.e. correct aspect ratio to match the screen size, such as 16:10), and the edges of the projection onto the impact screen must approximately reach the edges of the impact screen, etc.; and
3. Be in possession of a way of measuring the distance between 2 points on the impact screen, be it a tape measure or LiDAR measuring apparatus.

Once the above requirements are met, the operator can choose the screen configuration option on the game PC (which is typically located on the top right of the game window, as displayed on the PC screen in the set up mode). In a typical configuration, the following screen configuration screen should be as shown in FIG. 9.

FIG. 9 depicts a configuration page as displayed on the impact screen 307 (though the impact screen 307 itself is not shown in FIG. 9), having an inner rectangle 905 and an outer rectangle 906 generated by the computerized projection computer program, which will be used for configuring the projection program during set-up to properly display the game image on the impact screen during play. The outer rectangle 910 represents the outer bounds of the game image when projected. The image as projected onto the screen should be enlarged so that the outer rectangle 910 is at or near the physical edges of the screen 307, but exactness of this is not critical, as long as no part of the inner rectangle 905 extends does not outside of the physical edges of the screen 307.

First, the operator must make four measurements of each of the sides of the rectangle 905 as displayed onto the impact screen in its installed position relative to the image projector. These measurements can conveniently be input into UI input boxes 906, 907, 908 and 909, for, respectively, the measurements of the lengths of the top, left, bottom, and right edges of rectangle 905. The operator can input these measurements by clicking on the input boxes 906, 907, 908 and 909 and typing in the respective measurements of the sides of the inner rectangle into the input boxes with common measuring units (using meters, for example) into each respective input field.

FIG. 10 depicts another view of the configuration display generated by the computerized projection computer program, without the input boxes displayed, showing the proportions of the inner rectangle 905 and outer rectangle 910 as displayed on the impact screen 307, with the “top value” double-ended arrow indicating, for example, the upper side 1010 to be measured.

The actual full projected configuration view will be co-extensive with the area occupied by the game image when operating, and will typically encompass all or substantially all of the impact screen area in its installed position relative to the projector. As stated above, it is not critical that some or all of the outer rectangle 906 extends past the edges of the screen 307, as long as no part of the inner rectangle 905 (that would interfere with the accurate measurement of the lengths of its sides) extends outside of the physical edges of the screen 307. Therefore, in making the measurements required for configuration, it is not necessary for the actual projection to fit the projector screen/tarp 100% as long as the inner rectangle being measured fully fits the projector impact screen 100%.

When measuring, the operator should be sure to carefully measure each side of the projected inner box 905 from corner to corner, and to input the measured values into their correct ones of the relevant input boxes on the screen, from where they are stored in the computer.

Once the operator(s) has (have) completed and input all the screen measurements as described, the operator can simply push the “next” button 1014 on the display and go to the next step, where the bay position configuration measurement step can be accomplished.

### Bay Position Configuration

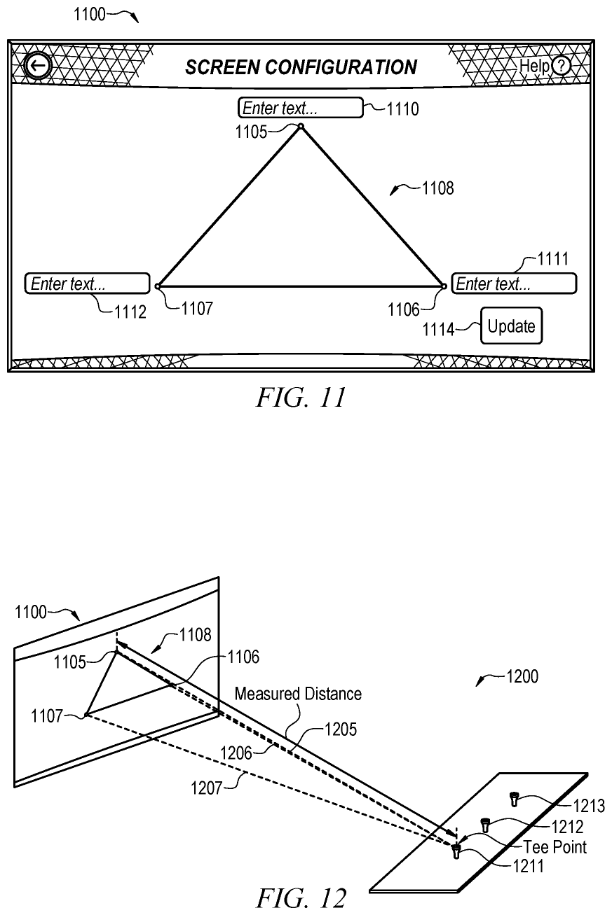

The bay positioning step, the display for which is shown in FIG. 11, involves a similar measuring process to the screen measuring step of the configuration step described above and depicted in FIGS. 9 and 10, except here the operator must measure from measuring points (i.e., the apices 1105, 1106 and 1107 on a triangle 1108 projected onto the screen 307 down to each of the tee-points in of the hitting bays (where the ball sits before being struck). When measuring, the operator will be measuring from the apices of the triangle displayed on the impact screen 307. It should be noted that two apices 1106 and 1107 at the base of the triangle 1108 can be at the same positions as the two bottom corners of the inner rectangle 905 previously measured as described above. The top apex 1105 of the triangle 1108 can be on the upper side 1010 of the inner rectangle 905, exactly at the midpoint of that upper side 1010. The foregoing positions simplify computations by the computer, and thus speed computer processing, particularly in essentially real-time, during game play, however, other locations are possible, as long as they are known to the computer program.

FIG. 11 depicts the configuration page 1100 generated by the computerized projection computer program showing the proportions of a configuration inner triangle 1108 disposed within the inner rectangle 905 depicted in FIG. 9 with its apices 105, 1106 and 1107 exactly touching the bottom and top sides of the inner rectangle, as displayed on the impact screen.

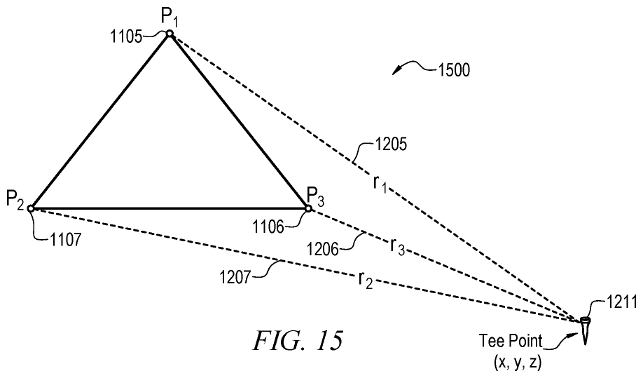

When measuring the distance from each of the measuring points on the screen, the operator will measure the straight line distances 1205, 1206 and 1207 from each of the on-screen point of each apex 1105, 1106 and 1107 to each one of the tee points 1211, 1212, and 1213, as shown in FIGS. 12 and 15. The foregoing positions simplify computations by the computer, and thus speed computer processing, particularly in essentially real-time, during game play, however, other locations are possible, as long as they are known to the computer program.

FIG. 12 depicts a simplified perspective view from the left and above of a horizontal set of three adjacent tee point 1211, 1212, and 1213 striking positions, the set being arranged with respect to a generally vertical impact screen upon which the configuration inner triangle of FIG. 11 is displayed, with dotted lines indicating three distance measurements to be made between the apices of the inner triangle to the left-most tee during configuration.

FIG. 15 shows the dotted lines to be measured from the apices 1205, 1206 and 127 of the triangle 1108 to tee point 1211, as an example, in more detail.

This process is repeated for each tee point in each bay. That is, where all three points on the on-screen triangle are measured from their position on the screen to, one at a time, of each one of the tee points. In the example shown in FIG. 12, there are three tee points, so there will three length measurement for each tee point, making nine total.

For each tee, once all the measurements to the apices 1105, 1106 and 1107 of triangle 1108 are made, they are input into the respective boxes 1110, 1111 and 1112. Then, when the “update” button 1114 is pressed, the dimensions are stored in the computer so that, as described below, the computer can make a trilaterate computation, which will be used in accordance with the invention for perspective correction.

Once both the screen dimensions and bay positions are measured for all tees, the configuration creation at set up will take place.

### Configuration Creation

The configuration creation is accomplished by a computer program coded to create a configuration file that tracks dimensions of the inner rectangle displayed on the impact screen, as described above, and the tee point positions relative to the screen, as measured as described above and as shown in FIGS. 12 and 15.

Additional configuration settings like API URL's can be provided for convenience, such as, whether the user is using imperial/metric system for in-game UI, connection information for in-bay devices, etc.

To accomplish the configuration creation described above, trilateration calculations will be performed by the game computer, as described below:

What the trilateration calculations provide are, for each of the bays' respective tee point x, y, z positions relative to the impact screen, is to construct a virtual environment by which the computer will calculate where the simulated ball trajectory intersects the game impact screen, which will then be used to determine scoring is some games.

To accomplish this, first, the computer must calculate the “real screen size” from the measurements taken on the projected game window.

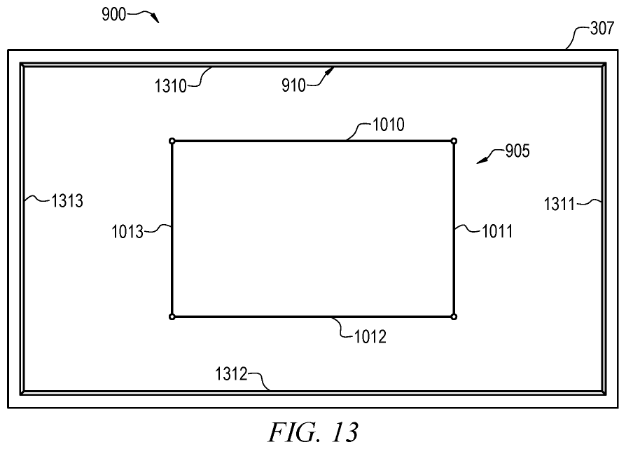

FIG. 13 depicts a simplified schematic view of how the inner and outer rectangles of the configuration display page 900 of FIG. 9 would appear as projected onto the impact screen 307 as installed. The inner rectangle 905 has a top side 1010, a right side 1011, a bottom side 1012 and a left side 1013. The outer rectangle 910, delimiting the game image, has a top side 1310, a right side 1311, a bottom side 1312 and a left side 1313. The sides of the inner rectangle 905 can each be exactly one-half the length of each of the respective sides of the outer rectangle 910, which will simplify and speed computer computations of ball trajectory. The foregoing positions simplify computations by the computer, and thus speed computer processing, particularly in essentially real-time, during game play, however, other locations are possible, as long as they are known to the computer program.

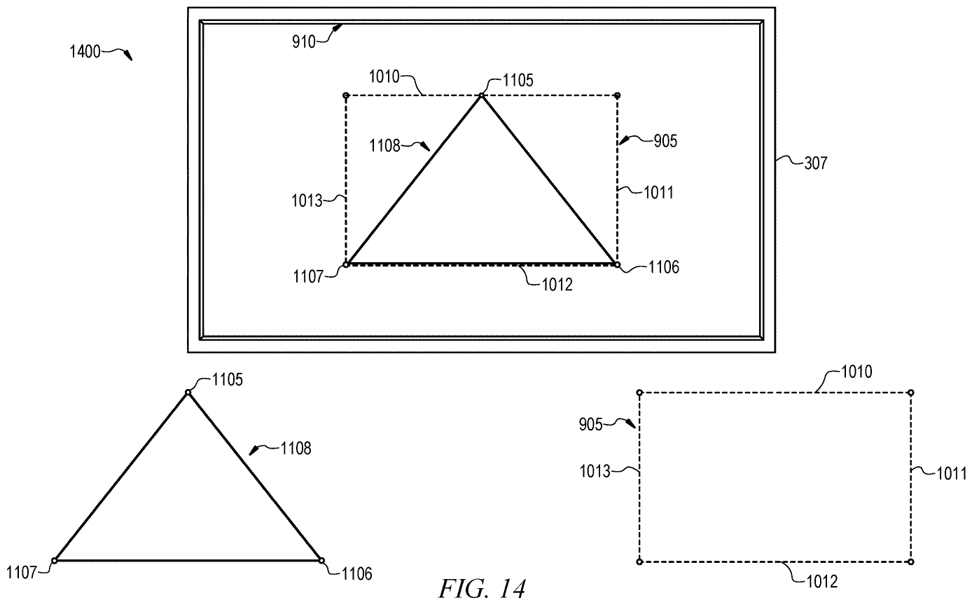

FIG. 14 depicts schematically the configuration inner triangle 1108 disposed within the rectangle 905 depicted in FIG. 9 with both superimposed onto the inner rectangle 905, here represented in dotted lines, both being disposed within outer rectangle 910. For clarity, inner triangle 1108 and inner rectangle 905 are each also shown separated at the bottom of FIG. 14.

As previously mentioned, the two apices 1106 and 1107 at the base of the triangle 1108 can be at the same positions as the two bottom corners of the inner rectangle 905 previously measured as described above. The top apex 1105 of the triangle 1108 can be on the upper side 1010 of the inner rectangle 905, exactly at the midpoint of that upper side 1010. For clarity, inner triangle 1105 and inner rectangle 905 are shown separated at the bottom of FIG. 14. Positioning inner triangle 1105 so its apex 1105 midpoint position of top apex 1105 and positioning the bottom apices 1106 and 1107 at the same as the two bottom corners of the inner rectangle 905, simplifies, and thus speed, computer computation of the ball trajectory. However, other locations are possible, as long as they are known to the computer program.

In both FIG. 13 and FIG. 14, the inner rectangle 905 that is displayed is of a known size and proportion to the full game image (bounded by outer rectangle 906) as projected onto the impact screen 307, referred to herein as “RealScreenSize.”

Also, in both FIG. 13 and FIG. 14, the respective sides 1010, 1011, 1012 and 1013 of the inner rectangle 905, referred to herein as “ScreenMeasurements”, can be exactly ½ of the length of the corresponding sides of the full game image rectangle 910, such that the inner rectangle as has an area exactly ¼ of area of the game image. As such, the values become:

$$RealScreenSizeTop = ScreenMeasurementTop \times 2$$

$$RealScreenSizeLeft = ScreenMeasurementLeftp \times 2$$

$$RealScreenSizeRight = ScreenMeasurementRight \times 2$$

$$RealScreenSizeBottom = ScreenMeasurementBottom \times 2$$

Note that “ScreenMeasurements” are from the inner rectangle.

With these measurements, the computer uses the tee point distances to the triangle apices measurements for each tee point in each bay, as described above, using the real impact screen 307 dimensions. This enables mathematical and geometric positioning of each tee point of each bay relative to the real impact screen 307, which will be used by the computer to determine the computed trajectory path for the ball from the tee point where it was struck to its impact point on the impact screen, and, for some games, the computed trajectory path as it continues past the plane of the impact screen.

To accomplish this, for each of the tee points in the bays, the computer will calculate their virtual position in the bays relative to the impact screen by using their respective positions relative to the screen via 3 lengths r1, r2, and r3, as depicted in FIG. 15, which depicts a simplified orthogonal view of one set of dotted lines indicating three distance measurements to be made during configuration between the apices of the inner triangle to one of the tees where a ball is to be struck and described herein.

Beginning with the variables and geometry depicted in FIG. 15, the trilateration step is accomplished as follows:

Using commonly-used computer code, the trilaterate function and equations can be written as follows:

```
bayPosition=
Trilaterate(topPoint,bayTopCenter,leftPoint,bayBottomLeft,rightPoint,bayBottomRight)\
Where the trilaterate function is defined as:
  public static Vector3? Trilaterate(Vector3 p1, float r1, Vector3 p2, float r2, Vector3 p3,
float r3)
{
  var ex = Vector3.Normalize(p2 − p1);
  var i = Vector3.Dot(ex, p3 − p1);
  var temp = p3 − p1 − i * ex;
  var ey = Vector3.Normalize(temp);
  var ez = Vector3.Cross(ex, ey);
  var d = Vector3.Distance(p1, p2);
  var j = Vector3.Dot(ey, p3 − p1);
  var x = (r1 * r1 − r2 * r2 + d * d) / (2 * d);
  var y = (r1 * r1 − r3 * r3 + i * i + j * j − 2 * i * x) / (2 * j);
  var zSquared = r1 * r1 − x * x − y * y;
  var z = zSquared > 0 ? Mathf.Sqrt(zSquared) : 0;
  var result = p1 + x * ex + y * ey + z * ez;
  return result;
}
```

In mathematical nomenclature, the trilaterate function and algorithms that are computed in the computer can be represented as

$$\vec{ex} = normalize ( {\vec{P}}_{1} - {\vec{P}}_{2} )$$

i=ex·(\vec{P}₃−\vec{P}₁), where “.” is the dot product operator
\vec{tmp}=\vec{P}₃−\vec{P})−i. \vec{ex}, where “·” is the dot product operator

$$\vec{ey} = normalize ( \vec{tmp} )$$

\vec{ez}=\vec{ex}×\vec{ey}, where “X” is the cross product operator

The foregoing algorithms creates the x axis for our local coordinate system Project P₃ onto line defined by P₁ and P₂. This also creates the local basis for trilateration.

$$d = Distance ( \vec{P} + {\vec{P}}_{2} )$$

j=\vec{ey}·(\vec{P}₃−\vec{P}₁), where “·” is the dot product operator

$$x = ( {r}_{1}^{2} - {r}_{2}^{2} + {d}^{2} ) / ( 2 d )$$

$$y = ( {r}_{1}^{2} - {r}_{3}^{2} + {i}^{2} + {J}^{2} - 2 i z ) / ( 2 j )$$

z=√(r₁²−x²−y²) or 0 (if square root is invalid)

Note: “i”, “j”, and “k” each represent a scalar distance for one of the three legs from the tee to the screen.

And so for each bay, the position (x, y, z) of the ball-screen contact point for a ball struck from a particular tee, is defined by the components above.

### Point of Contact Translation

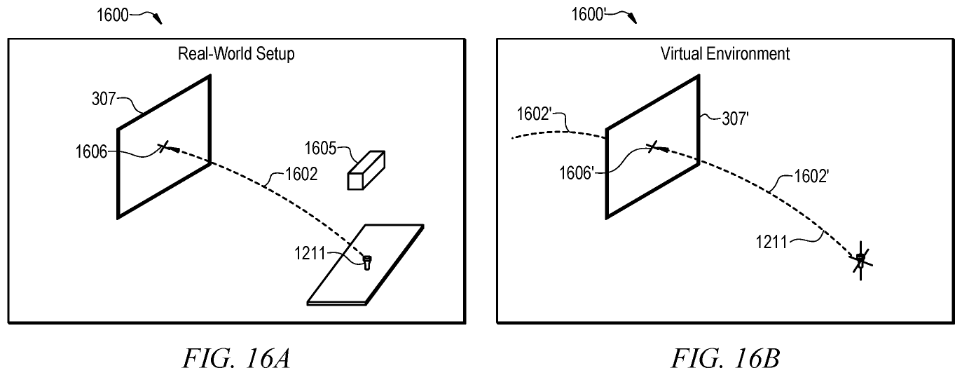

FIG. 16A depicts a simplified perspective view 1600 from the left and above of a real-world arrangement of a tee 1211 arranged with respect to a vertical impact screen 307 as installed showing an example ball flight path as detected by an overhead launch monitor device 1605. The computed trajectory of the ball 1602 is indicated by a curved dotted line and the impact point on the screen 307 is indicated by a cross 1606.

FIG. 16B depicts a simplified perspective view 1600′ of the virtual environment (that is, the computed environment in the game computer) showing a simulated flight path 1602′ representing the ball flight path 1602 as detected by the overhead launch monitor device 1605 of FIG. 16A and converted into a mathematical trajectory 1602′ in the computer, that will be scaled for realistic projection of the path of the ball onto a computed impact point 1606′, indicated as a cross on screen 307′, which is the computed representation of the physical screen 307 of FIG. 16A.

As depicted in FIGS. 16A and 16B, now that the positions of the tee points in space and the virtual screen dimensions are measured and known, the trajectory provided by the launch monitors and a ball trajectory computation engine, such as the InRange™ system, for example, can be used to determine the ball trajectory path 1602′. As shown in FIGS. 16A and 16B, this is defined by a set of virtual trajectory points for the calculated ball flight starting from the tee point 1211, for example, and progressing in the direction of our impact screen 307. Since a ball trajectory computation engine performs computations based on ball flight physics, air resistance etc., which are known to persons skilled in the art, the basic ball trajectory computation engine (of whatever brand), prior to application of the present invention, need not be further described.

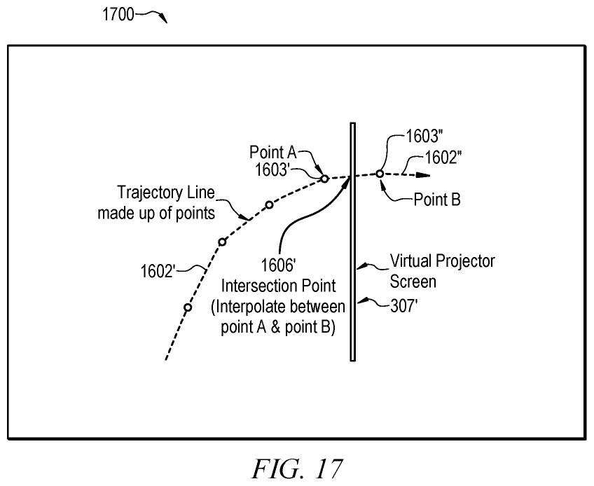

FIG. 17 depicts a simplified side view from the right of the virtual environment depicted in FIG. 16B, showing the simulated flight path 1602′ represented by a set of calculated points in space, including a point 1603′ nearest to virtual screen 307′, of the simulated ball flight path depicted in FIG. 16B. This path continues past the virtual screen 307′ along a flight path 1602″ on the back side of virtual screen 307′, including a point 1603″ nearest to the plane of virtual screen 307′.

As depicted in FIG. 17, to compute where the path of the ball flight as it intersects the screen, the computer interpolates the positions of the trajectory points 1603′ and 1603″ provided by the InRange™ (or other) trajectory computer system to find where one point lies in front of the virtual screen and which point lies behind the virtual screen. These points should be ones near the screen, on either side, the preferred being the closest points. From there, the computer can calculate where on the screen 307′ this intersection point 1606′ takes place. If that intersection point is calculated to be in a scorable area on the virtual screen 307′ (which mathematically corresponds to a scorable area as projected onto the physical screen 307), the computer system can register that position as a “hit” in certain of the games and display and store the score for that “hit.”

### Point of Contact Perspective Correction

Now that where the position the ball is hitting the screen, as computed by the ball trajectory computation engine is known, the final element of point of contact is using that information in-game.

A naive approach to using point of contact in-game is to “construct a 1:1 virtual environment to match the physical environment”, but two major issues arise from this:

Not all games have realistically scaled elements as projected onto the screen. For example; Castle Crush™, available from SmashSwingf™, uses cartoon houses, characters, and other environments not having familiar real dimensions. This eliminates any point of reference for dimensions of the targets or their distances for ball strikers, such as golfers, to hit their shots into the simulated environment, typically displayed as a perspective view but on a generally flat screen 307.

Although the use of a single perspective view in-game is good for a single, centrally located bay (e.g., a tee position in golf), for multi-player experiences, using conventional ball tracking systems, like InRange™, results in the shots of off-center players appearing to bend away from the trajectory path of the ball hat the player would view in real life. This can also makes it appear that, although the player may have hit a scorable area of an object at the physical point projecting the object onto the surface of the screen 307, this is not necessarily so for a large object represented in a perspective view as being a substantial distance into the depth of the projected screen, when the depth perception of the perspective view is taken into consideration. In this case, even if the physical ball hits a physical point on the screen where a scorable area is displayed, when the proportionalities of the perspective view are taken into consideration by the computer in computing the virtual path of the ball, the computed trajectory of the ball past the screen can be computed to not have hit the scorable area of the object displayed as far down-range, so no score would be awarded by the computer. This undesirably breaks player's expectations, however, since the applicant has determined that a player that hits a scoreable area on a target image displayed on the surface of the impact screen, in general, expects to receive a score for doing so.

To solve this problem, the Point of Contact solution for scoring, described below, is employed, such that a player that hits a scorable area displayed on the surface of the impact screen will receive a score, regardless of whether the trajectory of the ball past the surface of the screen would have hit the object at its perspectively-displayed location down range.

### Perspective Correction Solution

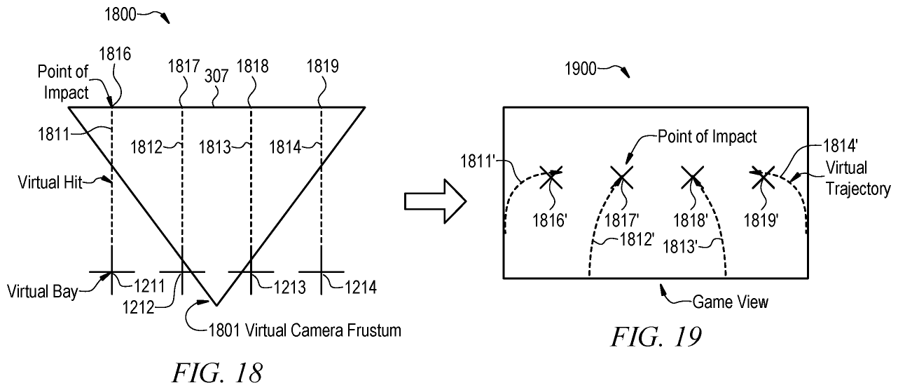

The Perspective Correction solution solves a problem existing in multiple player ball hitting games where conventional ball tracking and trajectory display systems project a simulated ball trajectory that is warped for players positioned at ball striking locations that are not centrally located in front of the impact screen. This is shown in FIGS. 18 and 19.

FIG. 18 depicts a simulation of a bird's eye view of four adjacent real-world physical ball flight paths 1811, 1812, 1813 and 1814 for four balls (not shown) hit from, respectively, four horizontally spaced apart tee points 1211, 1212, 1213, and 1214, with straight-ahead shots toward a toward a generally vertical impact screen 307, at an image projected onto the screen 307 by a projector (not shown) which located at the apex 1801 of the frustrum of the path of the light projected onto the screen 307. Viewed from above, each of the real-world physical bath paths 1811, 1812, 1813 and 1814 for each of the players' balls is straight, for balls hit straight at the screen, assuming no hook or slice. In this case, all four players would see their respective balls flying to the screen with only an up-down, parabolic arc, but with no curve to either side.

FIG. 19 depicts how, with conventional ball trajectory tracking technology, computed ball flight paths for four balls hit from, respectively, the four horizontally spaced apart tee points 1211, 1212, 1213 and 1214 would appear as projected onto the screen 307, for the same straight-ahead shots toward the generally vertical impact screen 307 of FIG. 18, prior to application of the perspective correction of an embodiment of the present invention. As can be seen, each of projected ball trajectories 1811′, 1812′, 1813′ and 1814′ of all four players appear, as viewed from the players' perspectives, in front of the screen 307, appear warped or curved to the left or right, even though the actual path of the physical ball was straight at the screen 307, with no left or right curve, and even though the respective simulated points of impact 1811′, 1812′, 1813′ and 1814′ onto the impact surface of the screen 307 are substantially aligned horizontally with the physical points of contact 1816, 1817, 1818, and 1819 depicted in FIG. 18.

To remedy the problem of the warped or curved appearance of the trajectories for shots from non-centrally located bays, i.e., tee points, as computed and projected during game play, the present invention includes an embodiment that employs a “perspective correction” computational technique, where all the virtual bays are aligned under a single in-game view perspective.

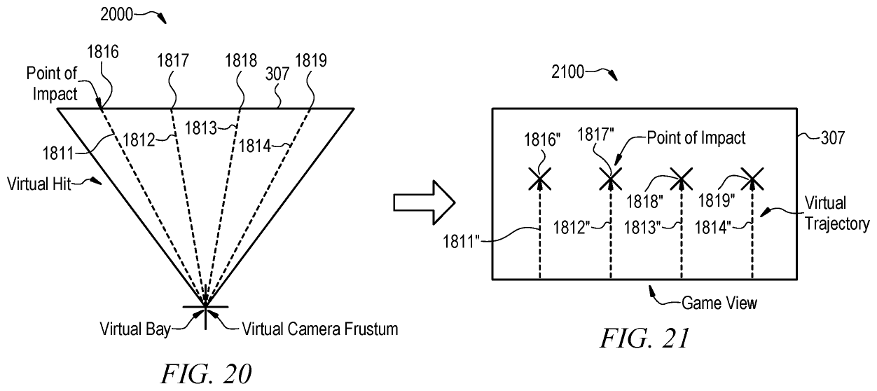

As depicted in FIGS. 20 and 21, this perspective correction technique achieves the result that all players have the experience found in a single player driving range (i.e. hitting a straight-forward shot displays a generally straight trajectory, that flies forward in a parabolic arc to an apex and then travels down on this arc until it hits the screen, but which appears, as projected onto the screen 307, as a straight up-down path, without warping or curving to the left or right, absent a hook or a slice.

FIG. 20 depicts a simulation of a bird's eye view of four adjacent simulated ball flight paths for four balls hit from, respectively, four horizontally spaced apart tees straight ahead toward a vertical impact screen, as they would appear to a centrally-located observer viewing the front surface of the impact screen, viewed from above, after application of the perspective correction of the present invention.

As depicted in FIG. 20, with the same virtual points of impact with the screen as depicted in FIGS. 18 and 20, but with their virtual trajectories as projected onto the screen 307 computationally rotated in accordance with the invention to ensure that, as depicted in FIG. 21, each of the four projected ball path lines 1811″, 1812″, 1813″ and 1814″, are straight up-down lines (assuming no hook or slice), to the points of impact 1816″, 1817″, 1818″ and 1819′. This aligns with how the ball path would appear in in real life with a real ball, from the standpoint of the player who hit his/her ball towards the screen 307. This matches each of the player's expectations of how of the ball flight for each player should appear, from the point of view of the player that hit the ball, regardless of whether the player is in the center bay or in a non-center, outer bay, away from a vertical plane bisecting the center of the screen.

As can be seen, each of the virtual bay trajectories still maintain their own trajectories, so when players hit off to the right or left their displayed trajectory will match their ball path.

FIG. 21 depicts a simulation of the four adjacent simulated ball flight paths for four balls hit from, respectively, four horizontally spaced apart tees straight ahead toward a vertical impact screen of FIG. 18, as they would appear to an observer viewing the front surface of the impact screen, after application of the perspective correction of the present invention.

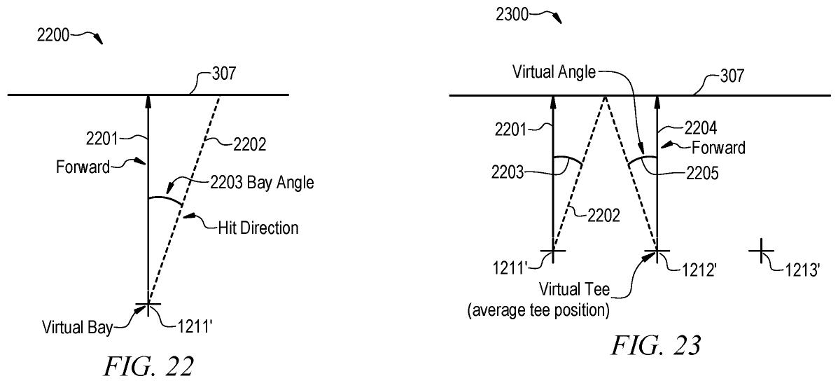

FIG. 22 depicts a schematic representation of a virtual bay from above, indicating a forward ball strike from a virtual tee point 1211′, with a solid arrow 2201 normal to the impact screen, and a dotted line 2202 indicating a hit direction at a bay angle 2203 away from the normal line.

FIG. 23 depicts a schematic representation of a virtual tee 1211′ and 1212′ from above, showing a hit from the left tee 1211′ to the right, and a hit from the right tee 1212′ to the left.

As depicted schematically in FIGS. 22 and 23, the image of the ball trajectory to the front surface of the screen will also be displayed on the screen from the standpoint of the player striking the ball, even where the player is positioned in one of the off-center bays where the tee is oblique to a vertical plane passing through the screen, and even where the direction of the ball trajectory strikes the screen at an oblique angle. In such instances, the trajectory of the ball is still displayed on the screen as it would be observed from the player striking the ball, as an essentially up and down straight line while in flight assuming no hook or slice, even though the player is positioned at a tee that is at an oblique angle to the screen 307, rather than a central position.

Of course, the trajectory of a ball struck from the center position will be displayed as observed by the player positioned at the center position. This will also be displayed as a straight shot toward the screen, with essentially only an up and down trajectory that will appear as a straight up-down line on the screen 307 by all players, whether they hit that ball or not.

It is noted that, even though a player standing to the left of right of the another player hitting a shot may have seen, in real life, some left or right curve when viewing the path of the other player's ball, even without a hook or a slice. However, in the present invention, with the perspective correction of the present invention, this apparent inconsistency is resolved in favor of retaining the up-down path image from the standpoint of the player who hit the ball, since that is the player most interested in that ball's path. As such, with the perspective correction of the present invention, there should be no right or left curve to the path of any ball, from any player, as projected onto the screen, except, of course, to the extent the trajectory computation determines that the ball is hooking or slicing to the right or left.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more machines, such as computers, computer processors, and/or other elements of a computer system. Such features are either impossible or impractical to implement mentally and/or manually. For example, embodiments of the present invention read data from a machine-readable object, such as by using a wand to read data from a chip. This function cannot be performed by a human manually or mentally.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s).

Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic discs such as internal hard discs and removable discs; magneto-optical discs; and CD-ROMs. Any of the foregoing may be supplemented by, or incorporated in, specially designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disc (not shown) or a removable disc. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A multi-player ball striking game device enabling play by multiple players striking balls at will in the direction of a target screen having a front surface configured as an exposed impact surface to receive impact from the balls, including from players striking balls simultaneously, comprising:
at least two adjacent single-player ball striking-off areas for holding each ball, the center of at least one of said striking-off areas being spaced apart substantially equally at least eight feet from the others and generally in a line facing the target screen, the target screen being the same target screen for all players and being positioned so as to be exposed on its entire front surface to direct impact by a ball struck by any player, the center of each striking-off area being disposed in a position for hitting each ball by a strike delivered by a player addressed at the ball on his or her striking-off area, and positioned so that, when the ball is struck in a normal manner toward the impact screen, it is likely to impact the target screen, and wherein at least one of which striking off areas is an oblique striking off area disposed off-center from a centrally-located vertical plane through the target screen;
one or more light projectors for projecting at least one computer-generated image onto the target screen, which image includes at least one target image having a scorable area;
the target screen being configured to receive light from the one or more projectors and to display the at least one projected target image having the scorable area; and further to receive the impact of each ball driven by each strike delivered by any of the players from any of the striking-off areas toward the impact screen, the screen having a generally upright area and being disposed away from the center of each of the striking-off areas;
at least one computer-controlled launch monitor device for determining the location a ball struck from each of the striking-off areas has or will impact onto the from impact surface of the impact screen after being struck, and which player struck which ball, whether that ball and/or other balls struck by different players will impact the impact surface of the target screen at the same time or different times;
the computer-controlled launch monitor device being further configured to compare the location of impact of a ball onto the impact surface struck by any of the players and to determine whether that location is within the scorable area of the at least one target image and, if so, to apply and store an achieved score for the player who struck the ball onto the scorable area; the score is being achieved substantially immediately upon it being determined that the ball has or will impact the front surface of the target screen at the location that the scorable area is displayed onto the front surface.

2. The multi-player ball striking game device of claim 1, wherein the computer generated image is a perspective image having an apparent depth resulting in the scorable area of the image having an apparent position past the front surface of the target screen that represents a substantia portion of that apparent depth, and wherein
the score is achieved immediately even where the apparent position of the scorable area of the image appears to be substantial distance past the front surface of the target screen as a result of the apparent depth of the perspective image.

3. The multi-player ball striking game device of claim 1, wherein the at least two adjacent single-player ball striking-off areas include at least one oblique striking off area located obliquely to a centrally located vertical plane through the impact screen, and wherein the computer-generated image includes an image showing a trajectory of the ball hit from the oblique striking off area towards the impact screen that generally represents the trajectory that would be observed by a person striking the ball from that oblique striking off area toward the impact screen.

4. The multi-player ball striking game device of claim 1, wherein the image of the trajectory forms part of the computer-generated image.

5. The multi-player ball striking game device of claim 1, wherein the trajectory image of a ball struck from the oblique striking off area is first computed in a first step by a computerized trajectory calculation system to determine an initial trajectory of the ball as it would be observed a centrally-located striking off area, and computationally modified in a second step by trilateral computations to compute a final trajectory that generally represents the trajectory that would be observed by a person striking the ball from that oblique striking off area toward the impact screen, and wherein both the first step and the second step are accomplished substantially in real-time.

6. The device of claim 1, wherein the computer has an arithmetic unit for calculating each player's running total score.

7. The device of claim 1, wherein the computer has an output to the light projector for projecting the score onto the screen.

8. The device of claim 1, wherein the computer has an output to the light projector for projecting each player's running total score onto the target screen.

9. The device of claim 1, wherein the target screen has a front and side edge connecting contiguously to a side wall portion disposed at an angle with respect to the front of the target screen and extending from it, the side wall portion also being configured to receive light from at least one projector to display at least one projected target image having a scorable area and to receive the impact of a ball driven by a strike delivered by at least one of the players from any of the striking-off areas.

10. The device of claim 1, wherein the target screen has a front and a top edge connecting contiguously to a ceiling portion disposed at an angle with respect to the top edge and extending from it, the ceiling portion also being configured to receive light from the at least one projector to display the at least one projected target image having the scorable area and being exposed on its entire surface to direct impact by a ball struck by any player to receive the impact of each ball driven by each strike delivered by at least one of the players.

11. The device of claim 1, wherein a sensor senses multiple parameters correlated to ball movement, the parameters comprising a vector.

12. The device of claim 11, wherein the vector includes the parameters of at least speed and direction.

13. The device of claim 12, wherein the vector further includes the parameters of ball spin speed and axis of spin.

14. The device of claim 1, a sensor comprises a camera pointed at the screen to sense location of a ball at the time of impact with the screen.

15. The device of claim 11, wherein the multiple parameters are sufficient to determine at least speed of the ball at the time of impact with the screen.

16. The device of claim 11, wherein the multiple parameters are sufficient to determine at least direction of the ball at the time of impact with the screen.

17. The device of claim 1, wherein the score is different for different locations of impact within the scorable area.

18. The device of claim 1, wherein the score is different for different speeds of impact within the scorable area.

19. The device of claim 1, wherein the score is different for different directions of impact within the scorable area.

20. The device of claim 1, wherein the device further comprises a competitive socializer element.
